(19) United States
(12) Patent Application Publication
(10) Pub. No.: US 2018/0198320 A1
(43) Pub. Date: Jul. 12, 2018

(54) SYSTEM AND METHOD FOR TRANSMITTING AND RECEIVING POWER WIRELESSLY

(71) Applicant: David R. Criswell, Houston, TX (US)

(72) Inventors: David R. Criswell, Houston, TX (US); Anatoliy Boryssenko, Belchertown, MA (US); Olena Boryssenko, Belchertown, MA (US)

(73) Assignee: David R. Criswell, Houston, TX (US)

(21) Appl. No.: 15/868,870

(22) Filed: Jan. 11, 2018

Related U.S. Application Data
(60) Provisional application No. 62/445,499, filed on Jan. 12, 2017.

(51) Int. Cl. H02J 50/23; H02J 50/27

(52) U.S. Cl. CPC H02J 50/23; H01J 25/50; H02J 50/27

(57) ABSTRACT

A WPT system and apparatus for the WPT system is provided in the present invention. The apparatus includes: (i) a transmitter, and (ii) a receiver. The transmitter transmits microwave power towards the receiver. The transmitter includes a power generation source, a CP horn and an antenna reflect array aperture. The receiver includes a rectenna array aperture. The rectenna array aperture further includes a sub-array module, a DC power output and a power conditioner circuit. The power conditioner circuit further includes a plurality of rectenna elements. The one or more sub-array module couple to form the rectenna array aperture.

### CROSS-REFERENCE TO RELATED APPLICATION

This application claims priority to U.S. Provisional Patent Application Ser. No. 62/445,499 filed on Jan. 12, 2017, the entire disclosure of which is incorporated herein by reference in its entirety for all purposes.

### BACKGROUND

### Technical Field

The embodiments herein generally relate to transmit and receive power, and, more particularly, transmitting and receiving power wirelessly.

### Description of the Related Art

The invention relates to the distribution of electrical power through the transmission and reception of microwaves, and, more specifically to wirelessly transmitting and receiving microwave power. Civilization demands power including power generation, storage, and transmission particularly to remote areas. Historically, the only reasonable means for power transmission and reception was through power lines.

Power transmission lines from one location to another location requires cable-like large extension cords. Power transmission from such cables includes favorable and unfavorable aspects. Power transmission over such cable systems suffer losses from the cable's inherent resistance and environmental loss is also seen. Further, such cable systems require substantial equipment and physical space. In addition, such cable systems often require rights of way and governmental approvals. In addition, any interruption of such transmissions affects the entire dedicated electrical pathway. In addition, installation of such cable system is costly and time consuming, and distributing power using such a cable system to places that are remote and difficult to reach, e.g., mountain tops and islands, by its very nature, is costly.

One can overcome the aforementioned and other drawbacks by employing the wireless power transmission (WPT) system. Historically, WPT uses electromagnetic waves as the medium that carries the energy for delivery from one location to another but these systems suffer from (i) a limited operational range, short and long, (ii) a lack of directivity and focus, (iii) a range limiting reflector relay structure, and (iv) a single channel operation.

The WPT distribution system of this invention (WPTDS) offers directed focused microwave transmission without the infrastructure and space demands of cable systems. Complications due to rights of way and governmental approvals are substantially reduced. Power interruption can be resolved quickly and even emergency power distribution is conveniently available.

WPTDS is characterized by range as (i) near, (ii) intermediate, and (iii) far. While the details of WPTDS may change based upon this range objective, the basic architecture of WPTDS remains constant. The physical mechanism for microwave propagation is common for all wave-based WPT. WPTDS overcomes WPT limitations of reduced operational range, limited power availability, and other performance limitations.

The structure of WPTDS employs two functional components; a transmitter component, and a receiver component.

(i) The transmitter having a transmitter aperture includes (i) a power source of electricity and a converter from electricity to microwaves, (ii) distribution control circuits that allocate and deliver microwaves to respective individual microwave radiators, and (iii) a reflectarray antenna having an array of microwave radiators including an aligner to direct and focus the cumulative microwave radiation beam from the radiator array to a predetermined destination location.

(ii) The receiver having a receiver aperture includes (i) a rectenna antenna having an array of individual microwave radiation antenna elements that capture the microwave energy at the predetermined destination location, (ii) collection control circuits that collect the microwave energy, (iii) rectifier circuits that convert the microwave energy into AC or DC electricity.

Wireless power transmission between two distant points requires an efficient system that manages the various system losses. Employing the general architecture of a transmitting reflectarray antenna and a receiving rectenna antenna, both of which are array antenna systems provides the foundation of the WPTDS. Phased array antenna is an additional option for such equipment. Array size, microwave frequency, power density, transmission power, transmission length, system efficiency, distribution circuitry, collection circuitry, multiple transmission beams, multiple reception beams, and data over power structures have not been designed or implemented in WPT systems. The present invention provides a solution for the overcoming the problems and short comings of WPT.

### SUMMARY

In view of the foregoing embodiment herein provides a Wireless Power Transmission and Distribution System (WPTDS). The apparatus includes: (i) a transmitter, and (ii) a receiver. The WPTDS includes a plurality of distance ranges for transmission and reception of the generated and transmitted power.

In one embodiment, the WPTDS system is used for the plurality of distance ranges including (i) a near, (ii) an intermediate, and (iii) a far range. In another embodiment, the WPTDS assembly remains constant for all the mentioned ranges.

A system for wireless power transmission (WPT) includes a transmitter and a receiver. In another embodiment, the transmitter transmits microwave power towards the receiver. In one embodiment, the receiver receives RF power and converts the RF power into a suitable DC form or AC form. In another embodiment, the transmitter and the receiver form a link for WPT between two remote spatial points.

The transmitter includes a power generation source, a CP horn and an antenna reflect array aperture. In one embodiment, the power generation source includes a first coaxial connector.

In another embodiment, the power generation source is selected from a group of a CW source of high range microwave energy, a magnetron, a solid-state source, a semiconductor amplifier, or the like. In one embodiment, the power generation source is a magnetron CW source. In another embodiment, the magnetron CW source couples to an AC power cord which provides initial input energy to the magnetron CW source. The CP horn includes a second coaxial connector and a coaxial cable. The first coaxial connector and the second coaxial connector connect the coaxial cable between the magnetron CW source and the CP horn for transceiving generated power from a magnetron CW source. Further, the antenna reflect array aperture includes a stand and a pair of holding arms. In one embodiment, at the transmitting side, the antenna reflects array aperture mounts on a stand. The antenna reflect array aperture focuses the electromagnetic energy in narrow radiated beams to support the required operational ranges. The antenna reflect array aperture includes an array of cell of size 4×4. The CP horn illuminates the antenna reflect array aperture. In one embodiment, the CP horn is held using a pair of the holding arm.

The receiver includes a rectenna array aperture. The rectenna array aperture further includes a sub-array module, a DC power output and a power conditioner circuit. The power conditioner circuit further includes a plurality of rectenna elements. The one or more sub-array module couple to form the rectenna array aperture. The sub-array module is of size 4×3 according to an embodiment herein. The rectenna array aperture is in square shape or the like, according to another embodiment herein. In one embodiment, the rectenna array aperture mounts on a mechanical stand. Further, the DC power output of the rectenna array aperture is fed to the power conditioner circuit. In one embodiment, the power conditioner circuit measures the input current and the input voltage to calculate the input power. The power conditioner circuit receives the input power from the DC Output of the rectenna array aperture. The power conditioner circuit further includes a microcontroller (not shown in figure) and a DC load resistor. In one embodiment, the microcontroller reads and calculates a plurality of values of current, voltage, input power or the like. The power conditioner circuit converts the DC power output in a required DC or AC form. The microcontroller calculates the input DC power and DC/AC power on the load to enable automatic maximum power point tracking (MPPT). In another embodiment, the power conditioner circuit performs the maximum power point tracking. The MPPT operate to reach maximum efficiency by converting the captured RF power into DC power output. The MPPT adjusts the DC load resistor for the rectenna array aperture to maximize PCE (Power conversion efficiency). The maximum PCE is achieved by changing the switching frequency of the internal DC-to-DC or DC-to-AC converters. In one embodiment, the power conversion efficiency (PCE) is mathematically derived as PCE=P_{DC}/P_{RF}, where P_{DC} is the DC power output and P_{RF} is the captured RF power. In one embodiment, the PCE depends largely on plurality of factors as an input power and a load resistor. In another embodiment, the deviation of the input power caused by changes in the WPT link channel according to FIG. 1 will result in lower PCE of the WPT rectenna.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

FIG. 1 is a diagrammatic representation of a system for wireless power transmission (WPT), according to an embodiment herein;

FIG. 2 represents a block diagram of the transmitter of FIG. 1 according to an embodiment herein;

FIG. 3 is a diagrammatic representation of a magnetron assembly of the magnetron CW source of FIG. 2 according to an embodiment herein;

FIG. 4A is a diagrammatic representation of a square cross-section of the CP horn of FIG. 2 according to an embodiment herein;

FIG. 4B is a diagrammatic representation of a circular cross-section for the CP horn according to an embodiment herein;

FIG. 5A is a diagrammatic representation of an elliptical array aperture assembled from sub-array of reflect-array aperture according to an embodiment herein;

FIG. 5B is a diagrammatic representation of rotary shifter reflects array cell assembled from sub-array of the antenna reflectarray aperture according to an embodiment herein;

FIG. 6A is a diagrammatic representation of the operational principle of the antenna reflect array aperture according to an embodiment herein;

FIG. 6B is a diagrammatic representation of a rotary shifter reflectarray cell according to an embodiment herein;

FIG. 6C is a diagrammatic representation of a sub-array of the antenna reflect array aperture;

FIG. 6D is a diagrammatic representation of the plurality of metal septum oriented in random position according to an embodiment herein;

FIG. 7A is a diagrammatic representation of a beam steering technique with the plurality of metal septum rotating within the rotary shifter reflect array cell of the antenna reflect array aperture according to an embodiment herein;

FIG. 7B is a diagrammatic representation of a radiation pattern for broadside radiation generated from the plurality of rotated metal septum according to an embodiment herein;

FIG. 8A is a diagrammatic representation of a beam steering technique with the plurality of metal septum rotating within the rotary shifter reflect array cell of the antenna reflectarray aperture according to an embodiment herein;

FIG. 8B is diagrammatic representation of a radiation pattern for broadside radiation generated from the rotation of the plurality of metal septum at an angle of 30 degree according to an embodiment herein;

FIG. 9 is a diagrammatic representation, according to an embodiment herein, of the receiver 104 of FIG. 1;

FIG. 10 is a diagrammatic representation of the sub-array module of the rectenna array aperture of FIG. 9 according to an embodiment herein;

FIG. 11 is a diagrammatic representation of a rectenna linear sub-array module of the rectenna array aperture 1000;

FIG. 12 is a diagrammatic representation of an individual rectenna element of the sub-array module of FIG. 10;

FIG. 13 is a diagrammatic representation of a circuit arrangement for the rectenna's rectifier circuit of FIG. 12 according to an embodiment herein;

FIG. 14 is a diagrammatic representation of the rectenna element circuit with the series half-wave rectifier according to an embodiment herein;

FIG. 15A is a circuit arrangement of an 8-element rectenna circuit with the half wave series rectifier and a common load as a result of simulated experiment;

FIG. 15B is a graphical representation of simulation result between the power conversion efficiency (PCE) and the time;

FIG. 16A is a diagrammatic representation of front face view of a fabricated rectenna element of FIG. 12;

FIG. 16B is a diagrammatic representation of a back face view of a fabricated rectenna element of FIG. 12;

FIG. 17 is graphical representations for a simulated result obtains for impedance matching of a 5.6 GHz dipole antenna element;

FIG. 18 is a diagrammatic representation of an array of 8 rectenna element arranged on a board string in a linear manner according to an embodiment of herein;

FIG. 19 is a diagrammatic representation of a square array of 8×8 using rectenna element on a board strip;

FIG. 20 is a graphical representation for impedance matching of a 5.6 GHz in form of a 8×8 dipole antenna array;

FIG. 21 is a diagrammatic representation of a dual-linear-polarized antenna array; and

FIG. 22 is a perspective view of the rectenna element.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for wireless power transmission over large distances. The embodiments herein achieve this by providing a setup for wireless power transmission and distribution system with dedicated path. Referring now to the drawings, where similar reference characters denote corresponding features consistently throughout the figures, there are shown preferred embodiments.

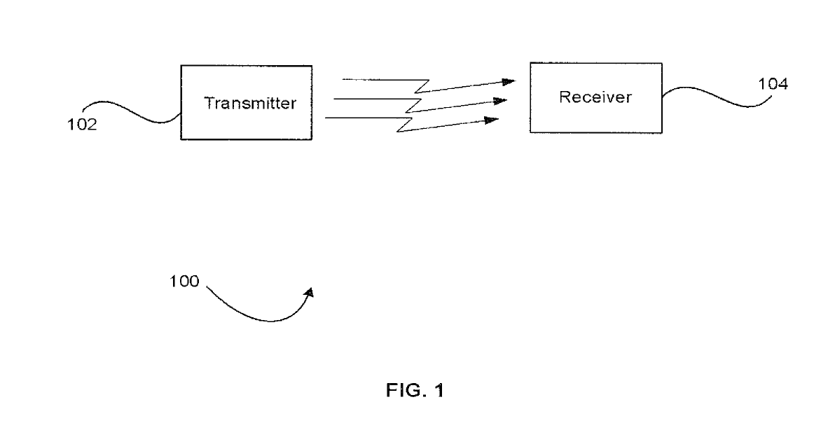

FIG. 1 is a diagrammatic representation of a system 100 for wireless power transmission (WPT), according to an embodiment herein. The system 100 includes a transmitter 102 and a receiver 104. The transmitter 102 transmits microwave power towards the receiver 104. The receiver 104 receives RF power and converts the RF power into a suitable DC form or AC form. The transmitter 102 and the receiver 104 form a link for WPT between two remote spatial points.

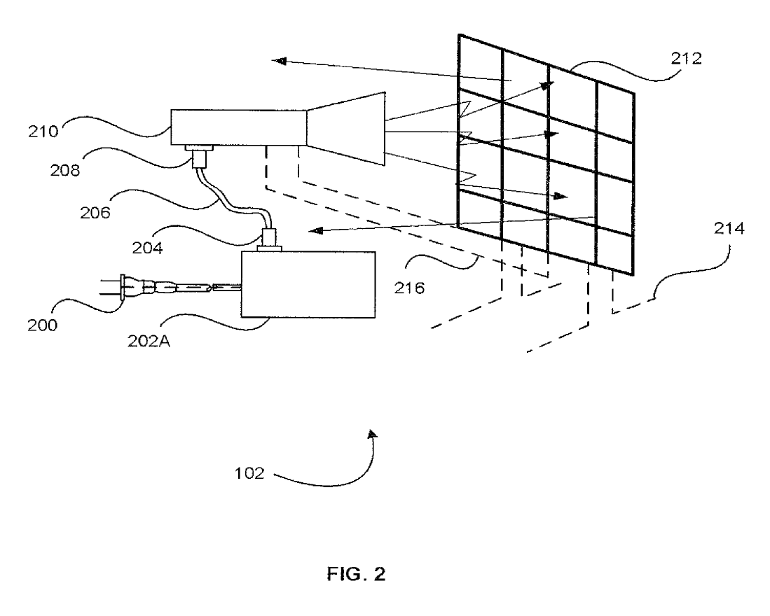

FIG. 2 represents a block diagram of the transmitter 102 of FIG. 1 according to an embodiment herein. The transmitter 102 includes a power generation source, a CP horn 210 and an antenna reflect array aperture 212. Further, the power generation source includes a first coaxial connector 204. In one embodiment, the power generation source is selected from a group of a CW source of high range microwave energy, a magnetron, a solid-state source, a semiconductor amplifier, or the like. In another embodiment the power generation source is a magnetron CW source 202A. The magnetron CW source 202A couples to an AC power cord 200 which provides initial input energy to the magnetron CW source 202A. The CP horn 210 includes a second coaxial connector 208 and a coaxial cable 206. The first coaxial connector 204 and the second coaxial connector 208 connect the coaxial cable 206 between the magnetron CW source 202A and the CP horn 210 for transceiving generated power from a magnetron CW source 202A. Further, the antenna reflect array aperture 212 includes a stand 214 and a pair of holding arms 216. In one embodiment, at the transmitting side, the antenna reflects array aperture 212 mounts on a stand 214. The antenna reflect array aperture 212 focuses the electromagnetic energy in narrow radiated beams to support the required operational ranges. The antenna reflect array aperture 212 includes an array of cell of size 4×4. The CP horn 210 illuminates the antenna reflect array aperture 212. In one embodiment, the CP horn 210 is held using a pair of the holding arm 216.

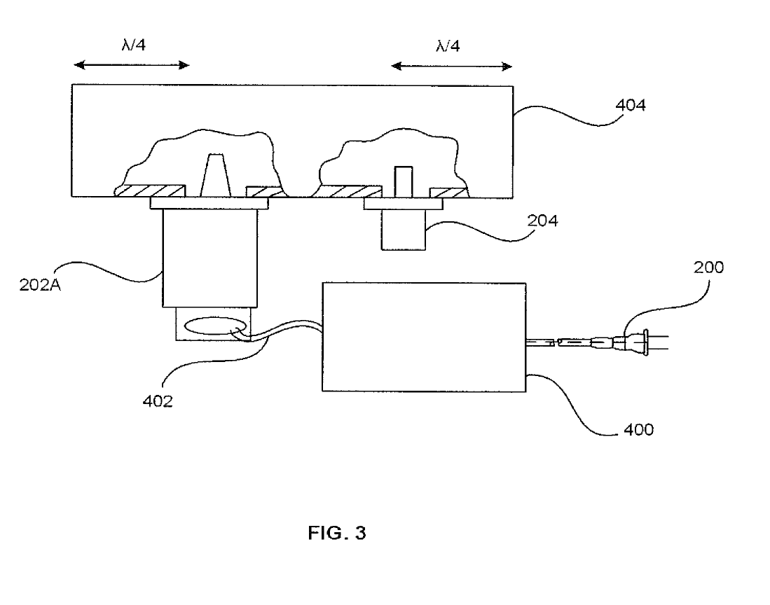

FIG. 3 is a diagrammatic representation of a magnetron assembly of the magnetron CW source 202A of FIG. 2 according to an embodiment herein. The magnetron CW source 202A further includes a microwave power controller 400, AC/DC magnetron wiring 402 and a waveguide section 404. The AC power cord 200 transfers the AC power towards the input port of the microwave power controller 400. The microwave power controller 400 400 couples to the magnetron CW source 202A using the AC/DC magnetron wiring 402. The magnetron CW source 202A is a straight section of the waveguide section 404. The wave guide section 404 is a rectangular cross-section including, but not limited to, WR974 of 9.750×4.875 inches for 900 MHz, WR430 of 4.300×2.150 inches for 2.45 GHz, WR159 of 1.590×0.795 inches for 5.6 GHz or the like for other operational bands. The waveguide section 404 includes one end with a small circular aperture on the bottom wide wall with the magnetron CW source 202A probe inserted in. Other, the small circular aperture with the coaxial connector 204 inserted in, coaxial connector 204 form transition between coaxial and waveguide transmission lines. The coupling apertures are made approximately at a distance of λ/4 from the waveguide section 404 ends, to enable impedance matching while adjusting the lengths of the inserted probes. The magnetron CW source 202A generates power and the microwave power enters the waveguide section 404 at the left from the magnetron CW source 202A and leaves from the right, through the coaxial connector 204, which is through a section of the coaxial cable 206.

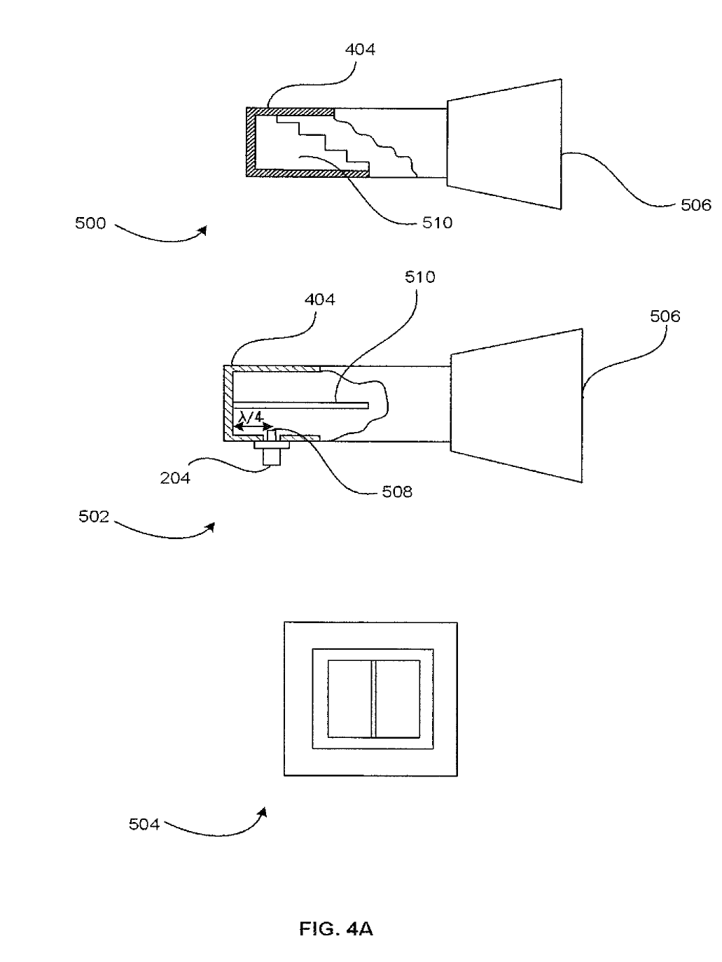

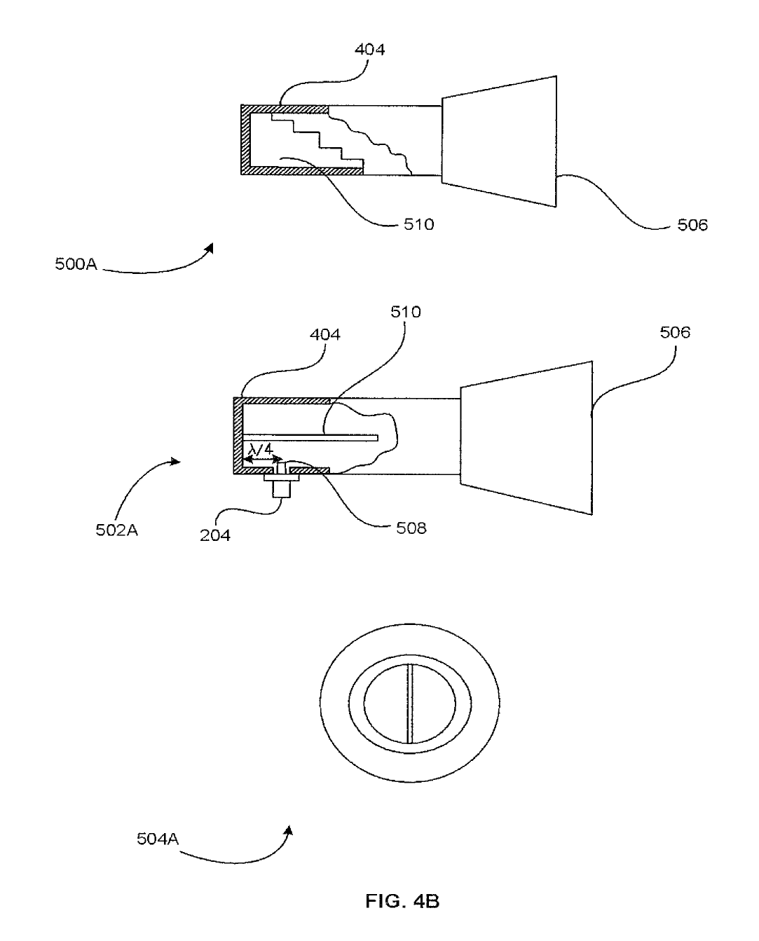

FIG. 4A is a diagrammatic representation of a square cross-section 500A of the CP horn 210 of FIG. 2 according to an embodiment herein. The diagrammatic representation includes a side cross-sectional view 500, a top cross-sectional view 502, a front view 504 and an adapter 508. In one embodiment the adapter 508 is a coaxial to waveguide adapter. The side cross-sectional view 500 of the CP horn 210 represents the waveguide section 404. The waveguide section 404 includes the CP horn 210 forming stepped height plate, a radiating horn section 506 and the coaxial connector 204.

FIG. 4B is a diagrammatic representation of a circular cross-section 500B for the CP horn 210 according to an embodiment herein. In one embodiment, the waveguide section 404 excites through the coaxial to waveguide adapter 506 and is installed at a distance of approximately λ/4 from the end of the waveguide section 404. A stepped septum metal plate 508 can be installed in the middle of the waveguide section 404 to convert the initial single-polarized excited mode field into two orthogonally polarized mode fields with quadrature (90 degrees) phase shift. The combination of square cross section 500A and circular cross section 500B from open aperture of the CP horn 210 radiates a circularly polarized EM wave.

The modular design principle is exploited here in which arbitrary size aperture can be assembled from identical building blocks, called sub-array modules. The reflect array aperture 212 may be rectangular shape and of any dimensions.

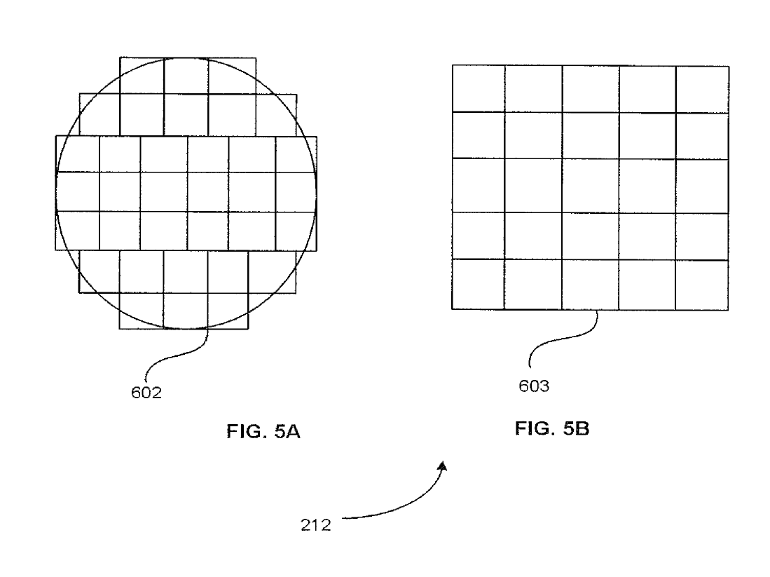

FIG. 5A is a diagrammatic representation of an elliptical array aperture 602 assembled from sub-array of reflect-array aperture 212 according to an embodiment herein.

FIG. 5B is a diagrammatic representation of rotary shifter reflects array cell 603 assembled from sub-array of the antenna reflectarray aperture 212 according to an embodiment herein. In one embodiment the rotary shifter reflect array cell 603 is square in shape.

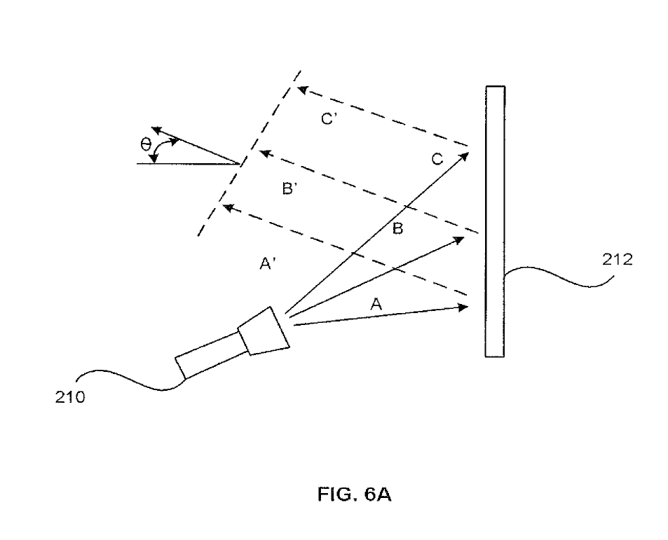

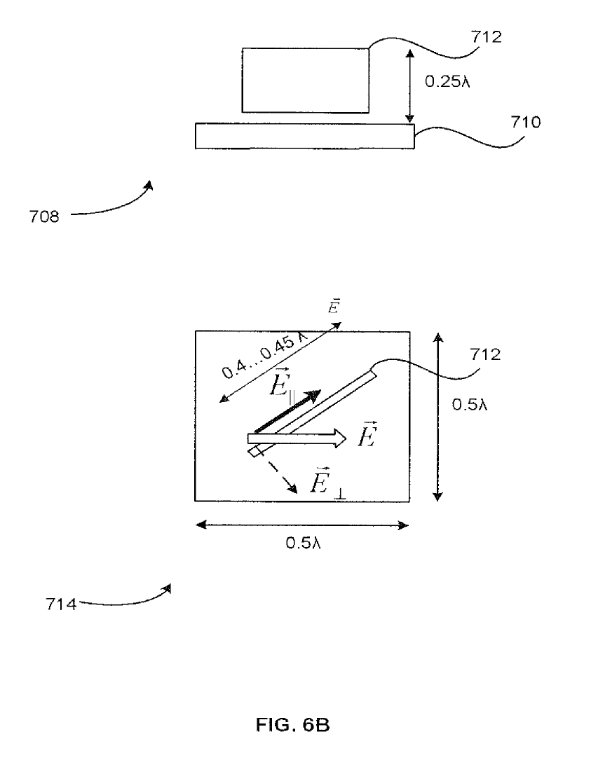

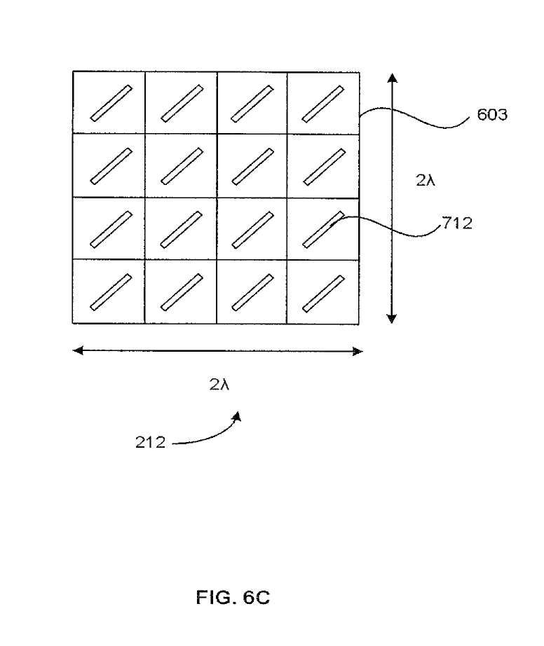

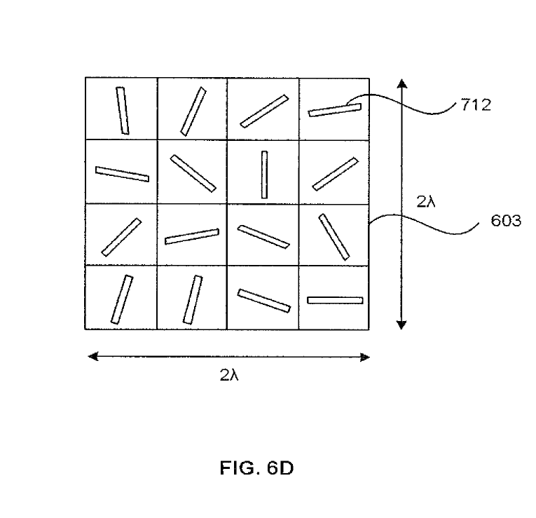

FIG. 6A is a diagrammatic representation of the operational principle of the antenna reflect array aperture 212 according to an embodiment herein. The plurality of rays A, B, and C shown in FIG. 6A radiate from the CP horn 210 and reach the surface of the antenna reflect array aperture 212. The plurality of rays A, B and C reflects with a plurality of additional phases inserted in the plurality of rays A, B and C, and propagate away from the antenna reflect array aperture 212 as A′, B′ and C′ rays. The plurality of additional phases is inserted in such a way that the electrical length for propagation path of each ray from the radiating horn section 506 to the assigned wave front remains the same. Additional phase defines beam scanning direction θ according to an embodiment herein. In another embodiment, the signal phases for paths A-A′, B-B′ and C-C′ remains the same.

FIG. 6B is a diagrammatic representation of a rotary shifter reflectarray cell 603 according to an embodiment herein. The rotary shifter reflects array cell 603 introduces a plurality of phase shift required to operate the antenna reflectarray aperture 212 of FIG. 6A. A side view 708 includes a metal ground base 710 and a metal septum 712. In one embodiment, the rotary shifter reflectarray cell 603 represents a top view 714, the metal septum 712 and different phase shifts introduced additionally to the metal septum 712. In another embodiment, the rotary shifter reflects array cell 603 is square shaped. The size of the rotary shifter reflects array cell 603 is 0.5λ×0.5λ, and the metal septum 712 is 0.25λ, in height and 0.4λ-0.45λ, in width. The metal septum 712 mounts on an axis in the middle of the rotary shifter reflect array cell 603. The metal septum 712 rotates to change the phase of scattered EM wave ‘E’ when a continuous polarized EM wave illuminates the metal septum 712. FIG. 6B further represents an arbitrary electrical vector in the plane according to an embodiment herein. The top view 714 includes a first component and a second component. The first component is parallel to the metal septum 712 and the second component is normal to the metal septum 712. In one embodiment, the top edge of the metal septum 712 reflects the first component. The second component does not interact with the metal septum 712. The ground plane reflects the uninteracted components by passing an additional distance which equals double height of the metal septum 712. In one embodiment, the uninteracted component introduces an additional phase to the scattered continuous polarized EM wave thus enabling beam steering.

FIG. 6C is a diagrammatic representation of a sub-array of the antenna reflect array aperture 212. The antenna reflectarray aperture 212 is assembled of rotary shifter reflect array cell 603 according to an embodiment herein. The reflect array sub-array is of size 0.5λ×0.5λ. The antenna reflect array aperture 212 is of size 2λ×2λ. In one embodiment, the rotary shifter reflect array cell 603 of the antenna reflect array aperture 212 includes a plurality of metal septum 712. The plurality of metal septum 712 is oriented in parking position.

FIG. 6D is a diagrammatic representation of the plurality of metal septum 712 oriented in random position according to an embodiment herein. The plurality of metal septum 712 rotates in different direction to support beam focusing in a given spatial pointing direction.

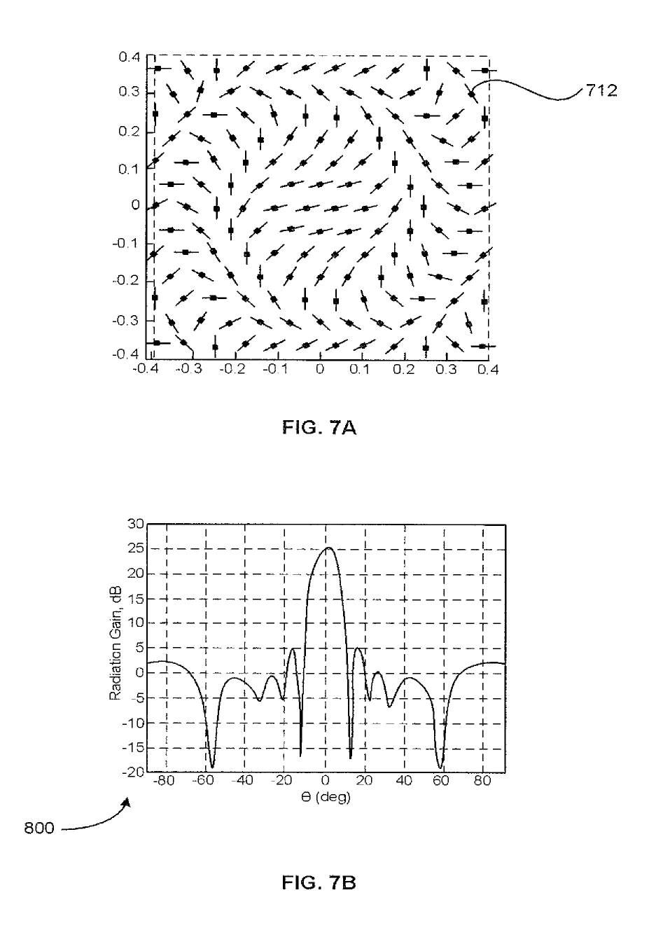

FIG. 7A is a diagrammatic representation of a beam steering technique with the plurality of metal septum 712 rotating within the rotary shifter reflect array cell 603 of the antenna reflectarray aperture 212 according to an embodiment herein.

FIG. 7B is a diagrammatic representation of a radiation pattern 800 for broadside radiation generated from the plurality of rotated metal septum 712 according to an embodiment herein.

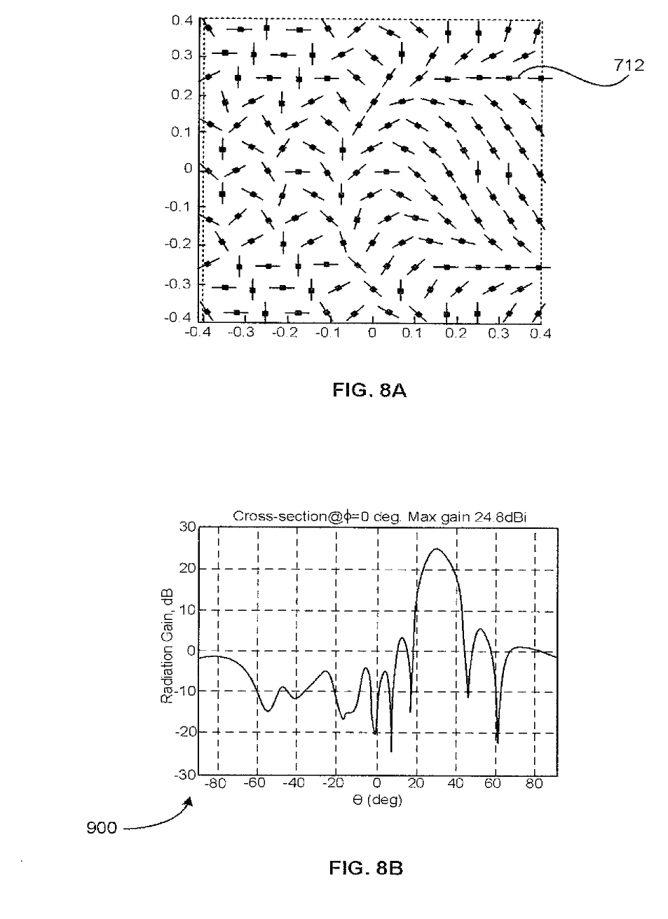

FIG. 8A is a diagrammatic representation of a beam steering technique with the plurality of metal septum 712 rotating within the rotary shifter reflect array cell 603 of the antenna reflectarray aperture 212 according to an embodiment. In another embodiment, the plurality of metal septum 712 rotates at an angle of 30 degree.

FIG. 8B is diagrammatic representation of a radiation pattern 900 for broadside radiation generated from the rotation of the plurality of metal septum 712 at an angle of 30 degree according to an embodiment herein. In another embodiment, the rotation is performed manually for fixed beam preset antennas or diverse electromechanical rotary actuators including but not limited to step motors, servos or other electrical motors and MEMS.

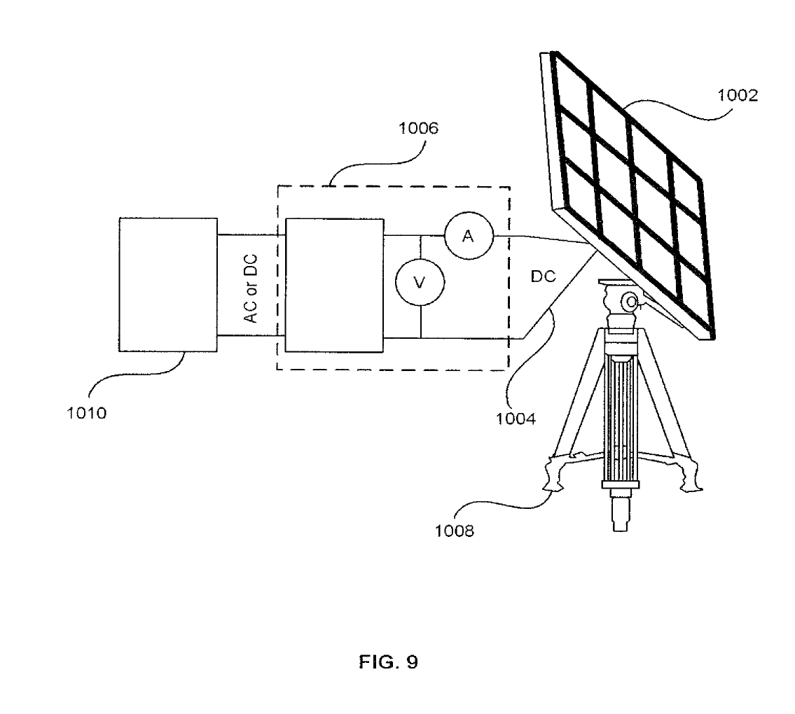

FIG. 9 is a diagrammatic representation, according to an embodiment herein, of the receiver 104 of FIG. 1. The receiver 104 includes a rectenna array aperture 1000. The rectenna array aperture 1000 further includes a sub-array module 1002, a DC power output 1004 and a power conditioner circuit 1006. The power conditioner circuit further includes a plurality of rectenna elements 1006A. The one or more sub-array module 1002 couple to form the rectenna array aperture 1000. The sub-array module 1002 is of size 4×3 according to an embodiment herein. The rectenna array aperture 1000 is in square shape or the like, according to another embodiment herein. In one embodiment, the rectenna array aperture 1000 mounts on a mechanical stand 1008. Further, the DC power output 1004 of the rectenna array aperture 1000 is fed to the power conditioner circuit 1006. In one embodiment, the power conditioner circuit 1006 measures the input current and the input voltage to calculate the input power. The power conditioner circuit 1006 receives the input power from the DC Output 1004 of the rectenna array aperture 1000. The power conditioner circuit 1006 further includes a microcontroller (not shown in figure) and a DC load resistor 1010. In one embodiment, the microcontroller reads and calculates a plurality of values of current, voltage, input power or the like. The power conditioner circuit 1006 converts the DC power output 1004 in a required DC or AC form. The microcontroller calculates the input DC power and DC/AC power on the load to enable automatic maximum power point tracking (MPPT). In another embodiment, the power conditioner circuit 1006 performs the maximum power point tracking. The MPPT operate to reach maximum efficiency by converting the captured RF power into DC power output 1004. The MPPT adjusts the DC load resistor 1010 for the rectenna array aperture 1000 to maximize PCE (Power conversion efficiency). The maximum PCE is achieved by changing the switching frequency of the internal DC-to-DC or DC-to-AC converters. In one embodiment, the power conversion efficiency (PCE) is mathematically derived as PCE=P_{DC}/P_{RF}, where P_{DC} is the DC power output and P_{RF} is the captured RF power. In one embodiment, the PCE depends largely on plurality of factors as an input power and a load resistor. In another embodiment, the deviation of the input power caused by changes in the WPT link channel according to FIG. 1 will result in lower PCE of the WPT rectenna.

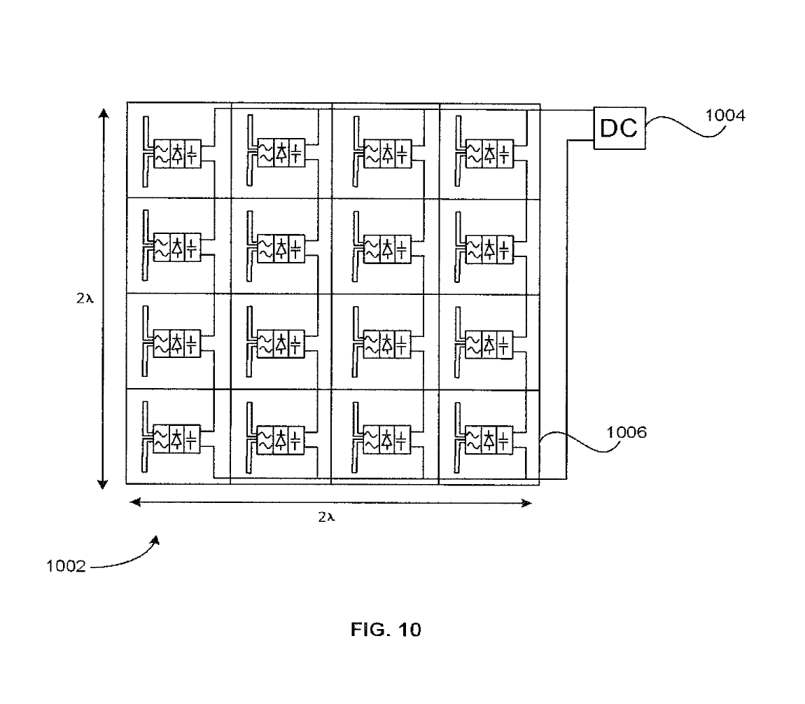

FIG. 10 is a diagrammatic representation of the sub-array module 1002 of the rectenna array aperture 1000 of FIG. 9 according to an embodiment herein. The sub-array module 1002 further includes a DC power output circuit 1004 and a plurality of rectenna elements 1006A. In one embodiment, the subarray module 1002 may be of arbitrary size and shape. The sub-array module 1002 is square in shape with size 4×4 according to an embodiment herein. The sub-array module 1002 is made of a set of individual rectenna elements 1006. In one embodiment, rectenna element 1006A spatially placed on an individual square array grid of approximate λ/2×λ/2 dimensions to enable maximum receiving efficiency of the rectenna. The DC power output 1004 of the individual rectenna element 1006A can combine in a serial-parallel fashion according to an embodiment herein.

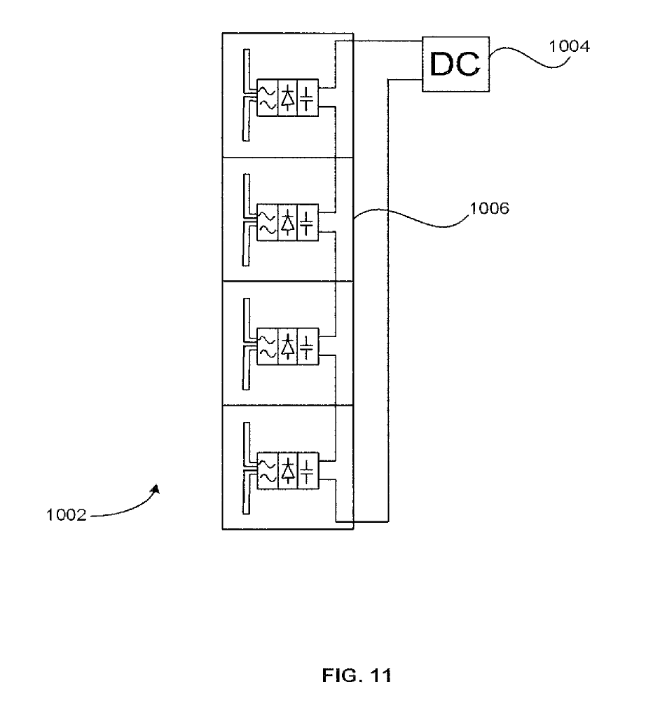

FIG. 11 is a diagrammatic representation of a rectenna linear subarray module 1002 of the rectenna array aperture 1000. The sub-array module 1002 is a linear subarray with size 4×1 according to an embodiment herein. Further, the linear subarray module output is connected to the DC Power output 1004. The DC power output 1004 of linear subarray module combined in series according to an embodiment herein.

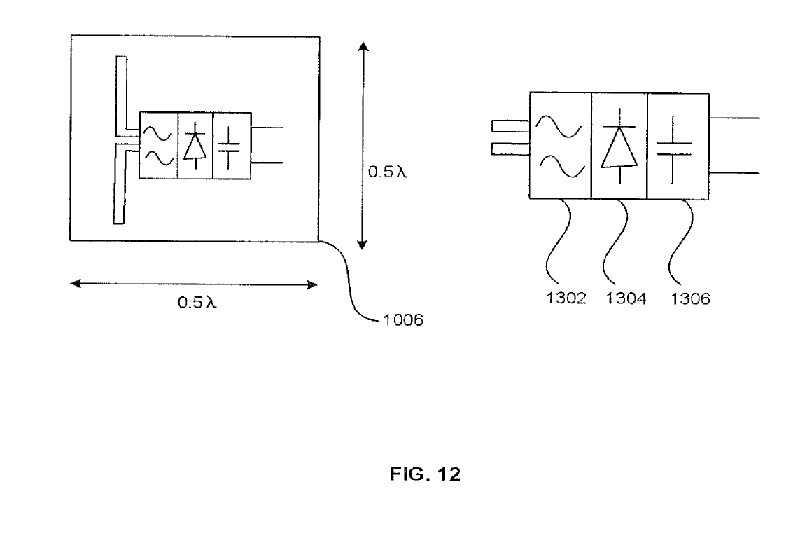

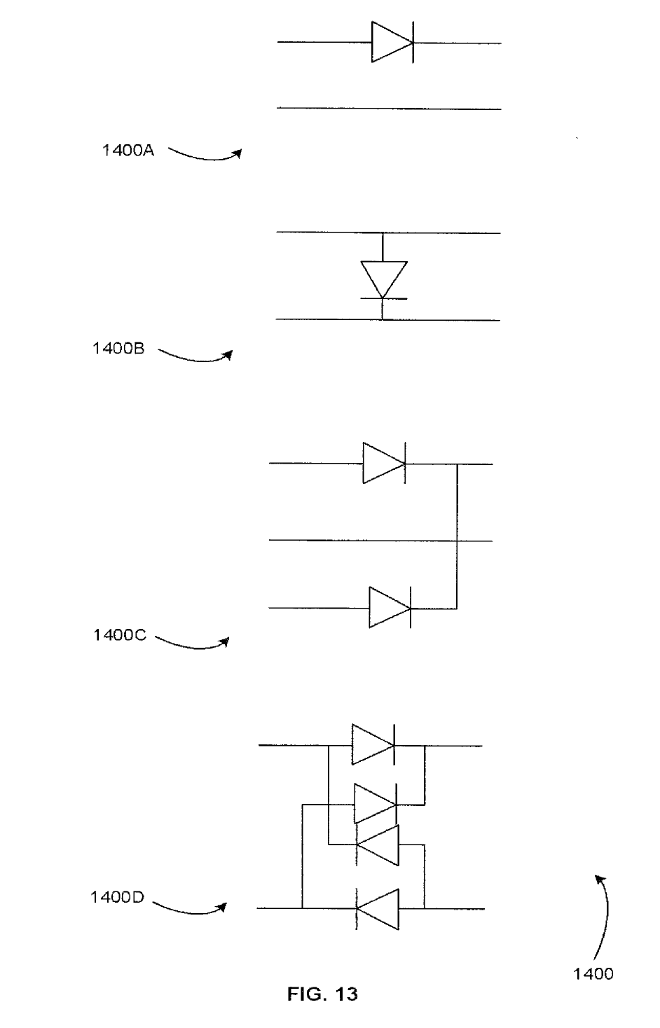

FIG. 12 is a diagrammatic representation of an individual rectenna element 1006A of the sub-array module 1002 of FIG. 10. The rectenna element 1006 is single polarized according to an embodiment herein. In another embodiment, the rectenna element enables maximum receiving efficiency of the rectenna array aperture 1000. The Rectenna element 1006A includes an input filter matching circuit 1302 and output low-pass filter 1306. The input filter matching circuit 1302 lies between the antenna element and a rectifier circuit 1304 according to an embodiment herein. The output low-pass filter 1306 lies between the rectifier circuit 1304 and the DC load resistor 1010 according to an embodiment herein. In one embodiment, the rectifier circuit 1304 with topology (circuit arrangement) is selected from a group of various circuit arrangements of FIG. 13. In one embodiment the rectifier circuit 1304 includes a diode ‘D’. The diode ‘D’ can be a microwave rectifier diode and is not operate as close as low-frequency rectifier diodes. The microwave rectifier diode ‘D’ give larger parasitic resistance and capacitance of the PN junction along with the parasitic packaging inductances and capacitors. In one embodiment, the large parasitic resistance results in the current flow through the PN junction of microwave rectifier diodes ‘D’ differently. In another embodiment, the large current flows through microwave rectifier diode ‘D’ and influences RF-to-DC conversion efficiency.

FIG. 12 is a diagrammatic representation of the rectenna element 1006A. The rectenna element 1006A is dual polarized according to an embodiment herein. The series arrangement combines the output of two microwave rectifier diode according to an embodiment herein.

FIG. 13 is a diagrammatic representation of a circuit arrangement for the rectenna's rectifier circuit 1006A of FIG. 12 according to an embodiment herein. A plurality of rectifier circuit 1400 may include, but not limited to, a series half-wave rectifier 1400A, a shunt half wave rectifier 1400B, a full-wave rectifier using a center tap 1400C, or a full wave rectifier 1400D.

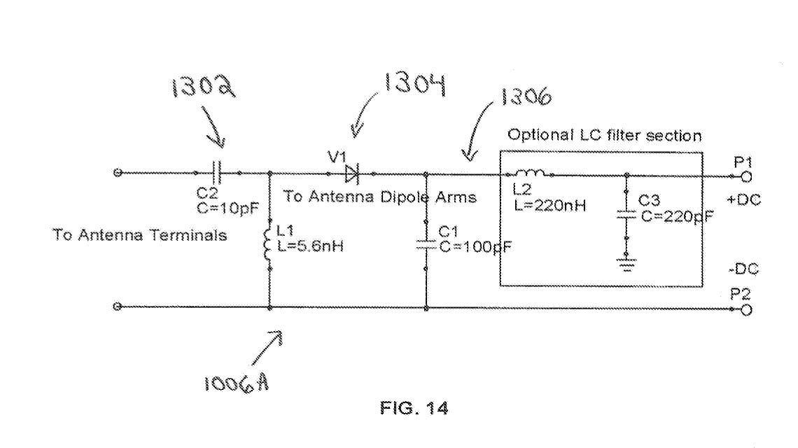

FIG. 14 is a diagrammatic representation of the rectenna element 1006A circuit with the series half-wave rectifier 1400A according to an embodiment herein. In an exemplary embodiment, the rectenna element 1006A further includes an input filter matching circuit 1302, a rectifier circuit 1304, and an output low-pass filter 1306. The high-frequency input filter 1302 is including two reactive components L₁ and C₂ and output low-pass filter 1306 is made of three reactive components C₁, C₃ and L₂.

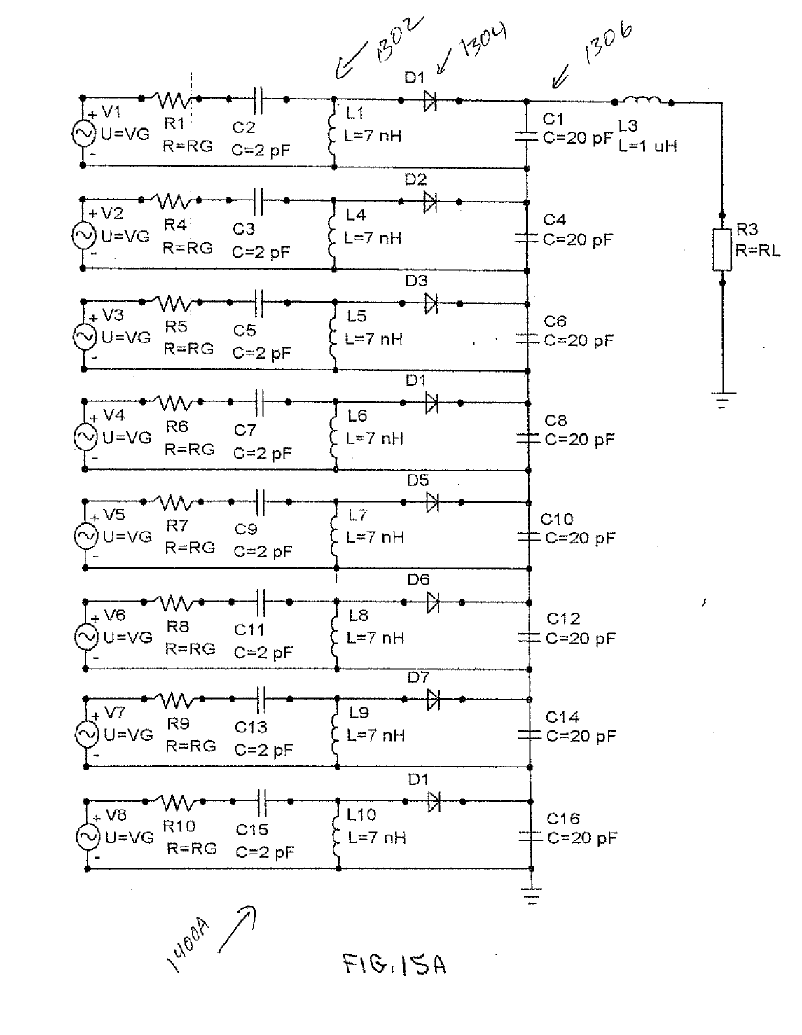

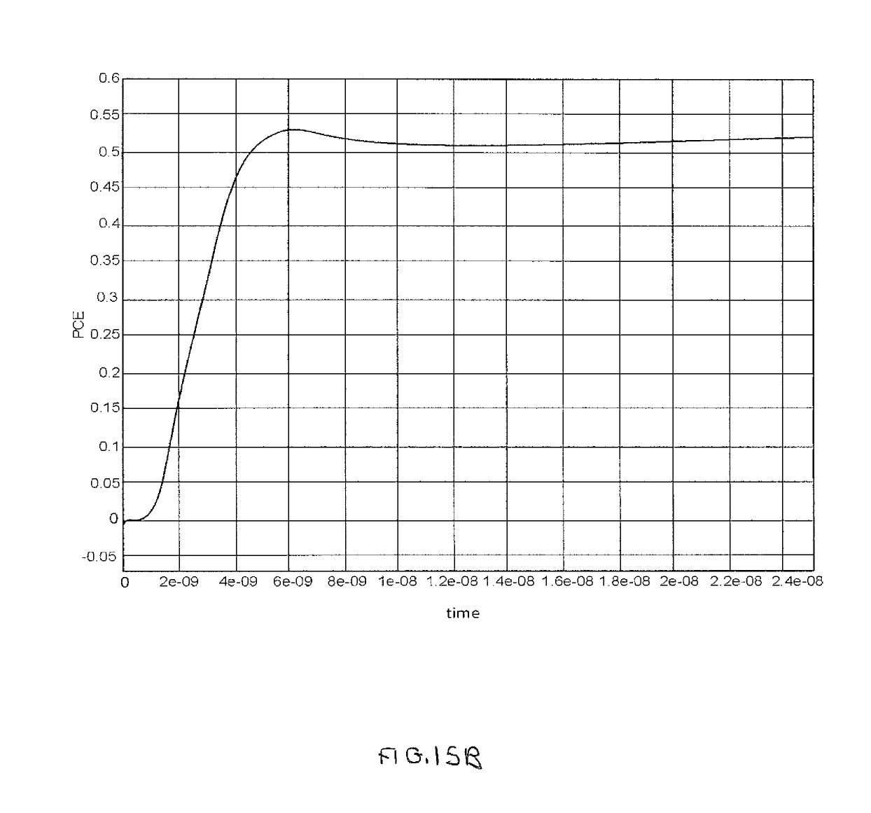

FIG. 15A is a circuit arrangement of an 8-element rectenna circuit with the half wave series rectifier 1400A and a common load as a result of simulated experiment. The multi-element rectenna simulation results locate better circuit topology and helps in bring optimal loading conditions.

FIG. 15B is a graphical representation of simulation result between the power conversion efficiency (PCE) and the time. The PCE reaches 50% of the total efficiency according to an embodiment herein.

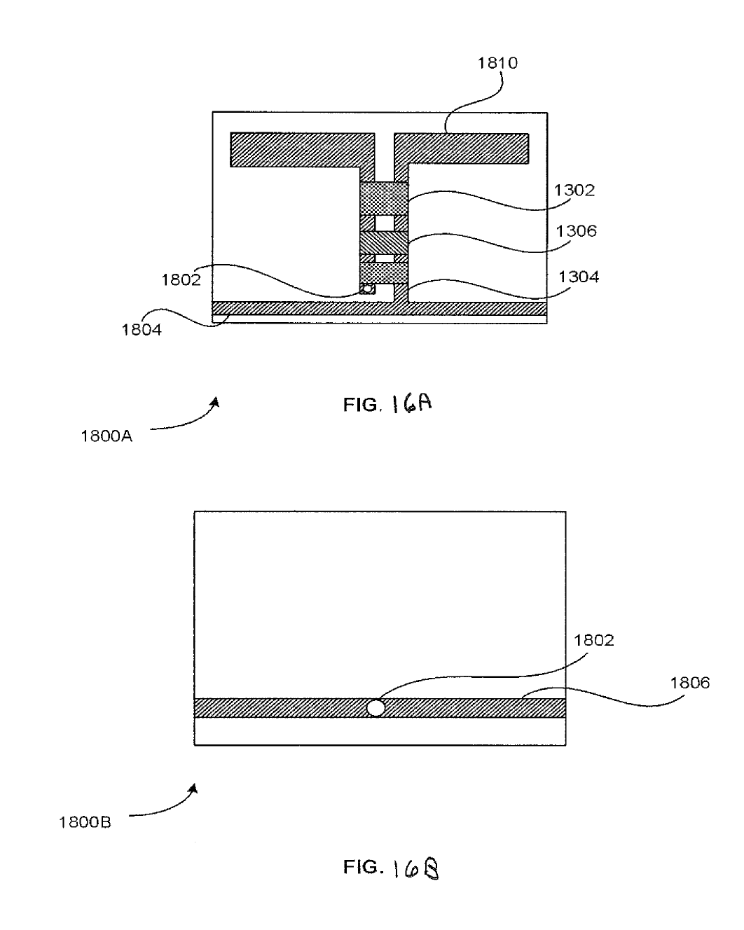

FIG. 16A is a diagrammatic representation of front face view of a fabricated rectenna element 1006A of FIG. 12. The rectenna element 1006A including an electromagnetic circuit component realized in hardware form 1800A. In one embodiment realized hardware 1800A is a patch element. The individual rectenna element 1006A is form using Printed circuit board (PCB) technology in the physical area of the antenna element unit cell (rectenna element 1006A) with the DC power output 1004. The realized hardware 1800A including a plurality of communication buses. In one embodiment the plurality of buses is selected from a group of a DC plus bus 1804 and a DC minus bus 1806.

FIG. 16B is a diagrammatic representation of a back face view 1800B of a fabricated rectenna element 1006A of FIG. 12.

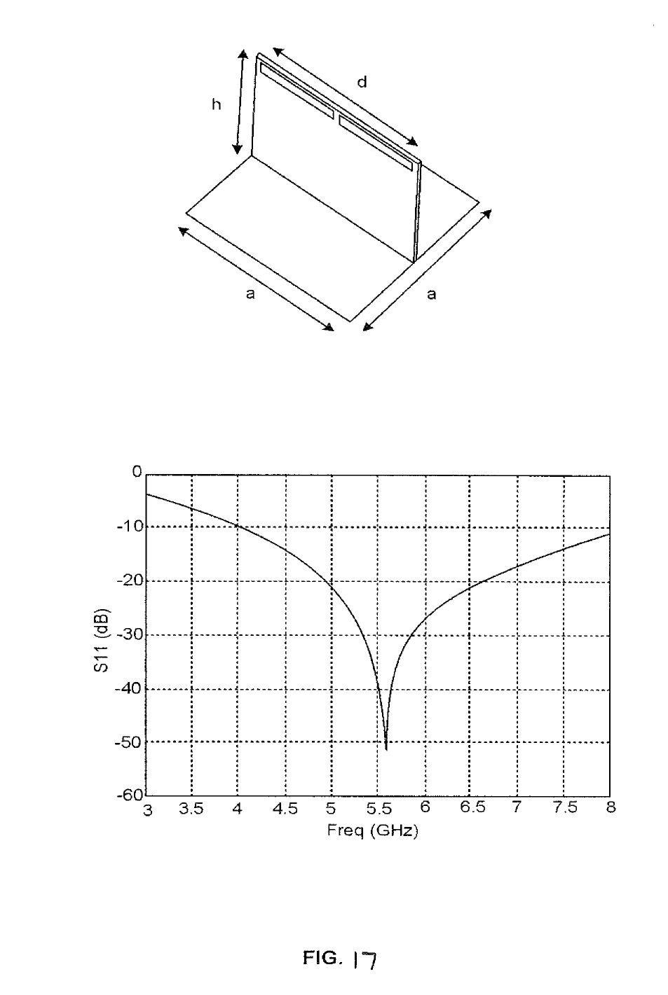

FIG. 17 is graphical representations for a simulated result obtains for impedance matching of a 5.6 GHz dipole antenna element. The graph shows a wide impedance bandwidth according to an embodiment herein.

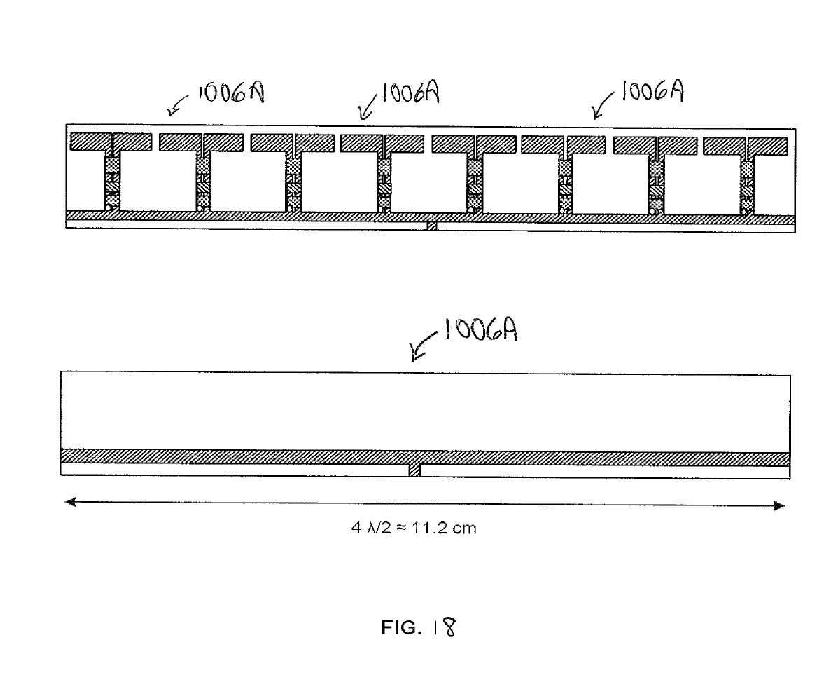

FIG. 18 is a diagrammatic representation of an array of 8 rectenna element 1006A arranged on a board string in a linear manner according to an embodiment of herein.

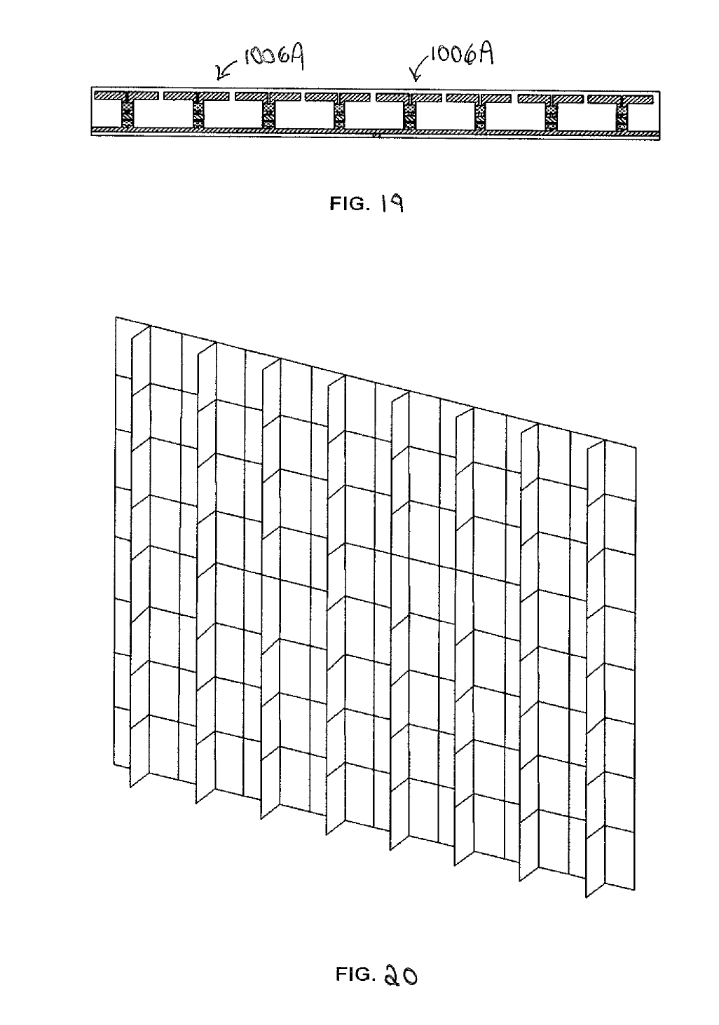

FIG. 19 is a diagrammatic representation of a square array of 8×8 using rectenna element 1006A on a board strip. The square array is a single-linear polarized according to an embodiment herein.

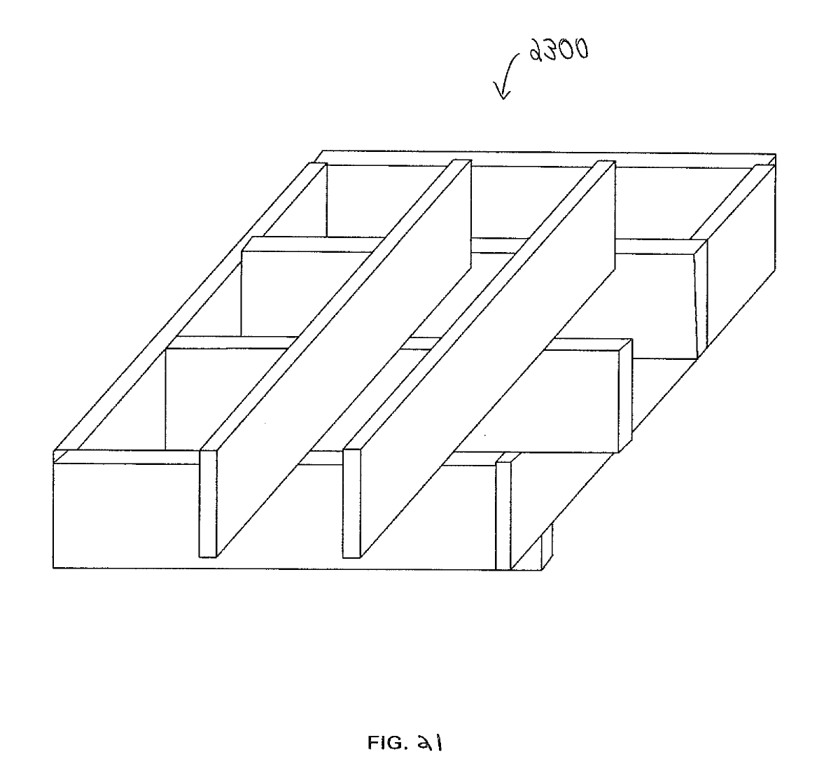

FIG. 20 is a graphical representation for impedance matching of a 5.6 GHz in form of an 8×8 dipole antenna array.

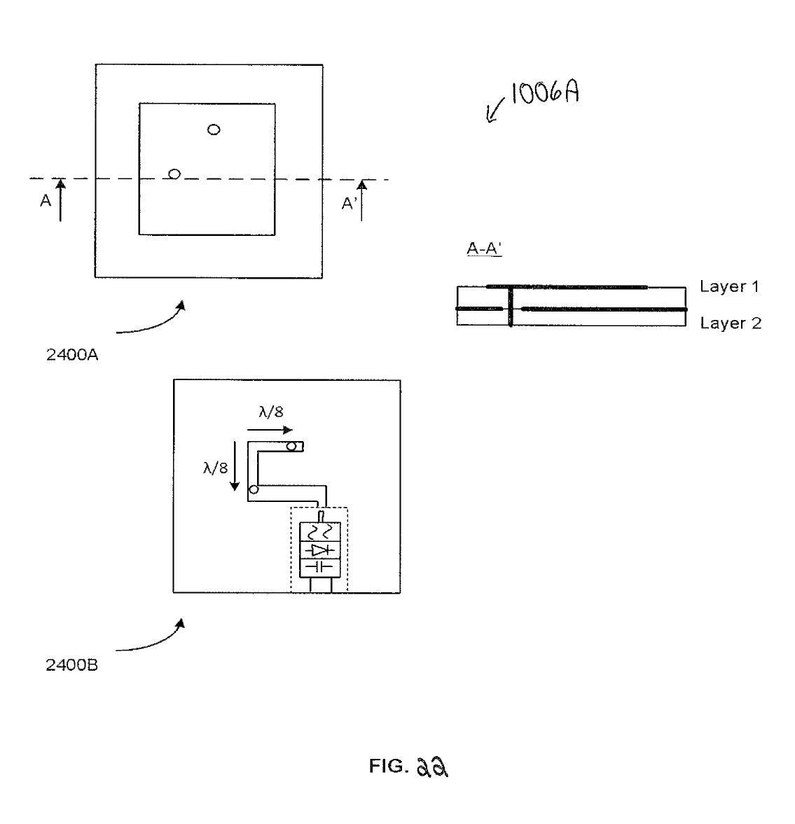

FIG. 21 is a diagrammatic representation of a dual-linear-polarized antenna array 2300. In one embodiment array 2300 is an “egg-crate”. In one embodiment the dual antenna array is a circular polarized. The array arrangement is using two rows and two columns. In one embodiment the two rows and two columns are of mutually orthogonal dipole radiators. In another embodiment the system is not conformal. In one embodiment using two linear polarizations in rectenna array allows to receive arbitrary polarization of transmitted EM waves.

FIG. 22 is a perspective view of the rectenna element 1006A. The FIG. 22 is including a top aperture view 2400A and a bottom aperture view 2400B. In one embodiment the rectenna element 1006A is a circular polarized patch element. In another embodiment the circular polarized patch element is conformal. In another embodiment the circular polarized patch element helps to enable CP horn 210 using with two radiation modes. In another embodiment the two radiation modes are driven in quadrature using a printed feed network. The CP EM energy from reflectarray 212 can be received by CP polarized patch or dual-linear polarized “egg-crate” dipole antenna of FIG. 21.

What is claimed is:

1. A wireless power transmitter comprising:
a source of electricity;
a converter of electrical power to continuous wave microwave power with a microwave power controller;
a wave guide section that receives the microwave power from the converter and forwards the microwave power through a coaxial connector and cable to an input microwave stub of a modular high-gain high power radiating antenna having a feed horn having a horn wave guide section, a conical horn section and a stepped septum located within the horn wave guide section and a reflectarray;
the feed horn and the reflectarray are supported on respective mount supporters;
the reflectarray aperture is illuminated by the feed horn;
the reflectarray includes a plurality of reflect array cells approximately 0.5 L by 0.5 L arranged in an array to receive a portion of the microwave radiation and the reflectarray cell having a vertically mounted rotatable septum with dipole exciters to reflect the microwave radiation impinged upon the cell from the feed horn;
excitation circuitry for each cell respectively applies a beam steering phase adjusted microwave signal to the excitation element of each cell, said phase adjusted microwave spinal being enabled by rotating the rotatable septum to a preselected orientation (based upon frequency of the microwave radiation, the aperture of the reflect array, the distance to the destination and the aperture of the destination receiving antenna).
